(19) United States
(12) Patent Application Publication
(10) Pub. No.: US 2015/0039752 A1
(43) Pub. Date: Feb. 5, 2015

(54) Advanced BACNet router

(71) Applicant: Edward Hague, Los Altos, CA (US)

(72) Inventor: Edward Hague, Los Altos, CA (US)

(21) Appl. No.: 14/121,094

(22) Filed: Jul. 30, 2014

Related U.S. Application Data
(60) Provisional application No. 61/859,860, filed on Jul. 30, 2013.

(51) Int. Cl. H04L 12/26; H04L 12/28

(52) U.S. Cl. CPC H04L 43/0876; H04L 12/2803
USPC 709/224

(57) ABSTRACT

In a BACnet Internetwork, a BACnet Router is configured to improve communications between BACnet devices by caching the addresses and data parts of messages sent between the devices, for diagnostic purposes, to avoid duplication of information, perform proxy functionality and address duplicate device and Network address information.

The present application claims priority from U.S. Provisional Patent Application 61/859,860 filed Jul. 30, 2013 in the name of Edward Hague.

### FIELD OF THE INVENTION

The invention relates to a router for a communications network. In particular it relates to a router in a BACnet Internetwork.

### BACKGROUND OF THE INVENTION

BACnet is a Data Communication Protocol for Building Automation and Control Networks developed under the auspices of the American Society of Heating, Refrigerating and Air-Conditioning Engineers (ASHRAE). BACnet is an American national standard, a European standard, a national standard in more than 30 countries, and an ISO global standard. The protocol is supported and maintained by ASHRAE Standing Standard Project Committee 135.

BACnet is used by devices in building automation, control and monitoring applications to communicate with each other and with host computer nodes over Ethernet, RS-485 and other communications media. These devices often control the Heating, Ventilation and Air Conditioning (HVAC), lighting, and security, provide energy management and multiple other aspects of a modern “Smart Building”, campus or city. BACnet is designed so that all these physical networks are linked together into a logical “BACnet Internetwork” and that all devices on the BACnet Internetwork can communicate with each other using their Network addresses established by their unique BACnet Device Object Identifier Instance numbers (for short: Device Instance Numbers or DIN) and unique BACnet Device Object Names

This invention is based on one of the standard BACnet devices: the BACnet Router, the operation of which is fully described in the BACnet standard. The invention expands on the basic functionality of the BACnet Router allowing for higher performance Networks, with better diagnostic capabilities, resulting in faster, more secure, more reliable, and less costly control Networks.

### SUMMARY OF THE INVENTION

According to the invention there is provided an Advanced BACnet Router (ABR) for linking together multiple BACnet Networks in a BACnet Internetwork of BACnet devices communication with each other using the BACnet protocol, comprising a processor that includes program logic to perform at least one of signal routing, application layer logic, and housekeeping to logically connect the BACnet Networks; transceivers for interfacing each BACnet Network with the processor, and at least one of a packet logging functional block, instrumentation electronics for measuring Network parameters, and a memory cache for storing at least one of messages, BACnet device information, and BACnet-protocol packets.

The packet logging functional block may perform at least one of logging of information, diagnostics, and packet forwarding. The tasks of the packet logging functional block may include at least one of monitoring of the processor, monitoring of the instrumentation electronics, performing calculations, and creating reports. The memory cache may be configured to store one or more of the first I-Am information generated by BACnet devices in response to Who-Is messages, the first I-Have information generated in response to Who-Has messages, and parameters and values of data objects within the BACnet devices. The cache may include BACnet device property information that is provided as part of a configuration process, and it may be configured to communicate with at least one of the packet logging functional block and an external work station. The packet logging functional block may include polling logic to actively poll for defined information and build the information in the cache, and it may be configured to perform diagnostic services for traffic and protocol monitoring by making copies of communications packets, and optionally adding timing and Network parameter information, and forwarding these to a diagnostic processor.

The BACnet Router may be configured to serve as a proxy for simple BACnet devices by including logic to perform a change of value service that generates a message when a change of value outside a defined delta range is detected for a BACnet device. The proxy functionality may also include adding a security layer based on the BACnet security standard. The instrumentation electronics may be configured to add resistor sequences to the connected BACnet Networks to diagnose termination and biasing conditions.

The BACnet Router may further comprise a diagnostic processor running diagnostic software, wherein the diagnostic processor includes at least one of a diagnostic display program and an operator interface. Still further, the BACnet Router may comprise a Cloud router.

Further, according to the invention, there is provided a method of improving communications between BACnet devices in a BACnet Internetwork that includes multiple BACnet Networks, the method comprising providing a cache to capture the addresses and data parts of messages sent between BACnet devices. The messages may be queued and duplicate messages may be deleted. The method may further comprise collecting Network topology information, which may include caching address/routing information of BACnet messages, which may include actively exploring the BACnet Networks using standard BACnet messages to build an internal map of the BACnet devices and their locations. The cache may be implemented in a BACnet Router, and may be configured to identify unauthorized or disconnected devices to allow the BACnet Router to prevent forwarding of messages to the unauthorized or disconnected device. Duplicate Device Instance Numbers and Device Object Names of BACnet devices, and duplicate Network Numbers of BACnet Networks on a BACnet Internetwork may be aliased or reassigned in the communications packet before forwarding. The aliasing may be performed automatically by a diagnostic processor communicating with the BACnet Router, or through an operator configuration using a workstation communicating with the BACnet Router. Transfer of broadcasts between Internet routers may be achieved by sending a BACnet packet associated with the broadcast along with additional addressing information that allows a Cloud router to transfer the BACnet packet with the additional addressing information to the appropriate BACnet Router where the BACnet packet part of the message is forwarded on to the BACnet Router's BACnet Internetwork.

### BRIEF DESCRIPTION OF THE DRAWINGS

FIG. 1 is a block diagram of a BACnet Internetwork as known in the art;

FIG. 2 is a block diagram of one embodiment of a BACnet Internetwork of the invention showing a BACnet Router of the invention in greater detail, and

FIG. 3 is a block diagram of one embodiment of multiple BACnet Internetworks of the invention linked to form a larger Internetwork.

### DETAILED DESCRIPTION OF THE INVENTION

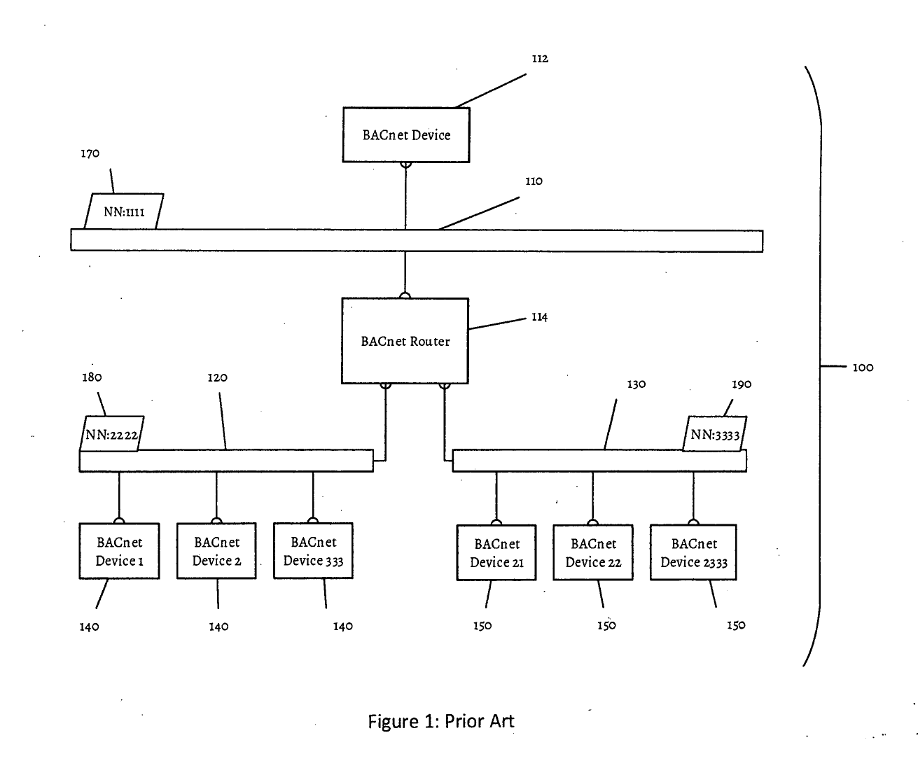

FIG. 1 shows a typical BACnet Internetwork 100, a term defined by the ASHRAE BACnet standard to describe a collection of BACnet devices 112, 114, 140,150, which are able to communicate with each other using the BACnet protocol over various physical BACnet Networks 110, 120, 130. Since the three physical Networks have different BACnet Network Numbers, and are of different physical types, they need to be linked together by a BACnet Router 114. For clarity the Network Numbers of the three BACnet Networks 110, 120, 130 are indicated in the label boxes 170, 180, 190.

The BACnet Internetwork 100 may, for instance, be based in a building or on a campus, in a particular geographical location. As mentioned above, in this prior art example, the Internetwork 100 includes a first BACnet Network 110, a second BACnet Network 120, and a third BACnet Network 130. The first Network 110 typically includes a BACnet client device 112, which may, for example, take the form of a BACnet Operator Workstation used to display data collected from all the other BACnet devices to an operator, a sophisticated BACnet controller acting in a supervisory control mode, or a simple BACnet device that needs to read or receive data from one or more of the other BACnet devices on the BACnet Internetwork. In the present embodiment the client device 112 is configured as a PC, which hosts a sophisticated BACnet Operator Workstation software program.

The BACnet protocol supports several possible BACnet physical media, including Ethernet, RS/EIA-485, LonTalk, wireless (WiFi, Zigbee, BlueTooth) etc. Each of the BACnet Networks 110, 120, 130 are assigned a unique Network Number. In this case, for the purposes of this embodiment, Network 110 has been assigned Network Number 1111, Network 120 has been assigned Network Number 2222, and the third Network 130 has been assigned the Network Number 3333.

The first Network 110 may for instance be a relatively high speed 100baseT connection, carrying BACnet/IP packets. The second BACnet Network 120, can also be implemented using any one of the possible BACnet physical media (Ethernet, RS/EIA-485, LonTalk, WiFi etc). The third BACnet Network 130, is similar to the second Network 120, but in this case it has been implemented as a BACnet/MSTP, which is the BACnet Protocol based on RS/EIA-485, and which has a relatively slow data transfer rate.

As shown in FIG. 1, the BACnet Network 110 includes at least one BACnet Router 114.

The Network 120, in this case, includes additional generic BACnet devices 140, which may take the form of a BACnet server, a BACnet client, similar to client 112, or simultaneously a BACnet server and client. These are the devices that normally act as measurement sensors, or actuators in a building automation network. However, they could also be implemented as operator workstations or BACnet Routers to support further BACnet Networks.

The devices 140 have numbers associated with them, which each defines a BACnet Device Instance Number forming part of a BACnet Object Identifier for a device. These Device Instance Numbers are required to be unique on any given BACnet Internetwork for proper operation. In this example, the Device Instance Numbers, for simplicity, are chosen as 1, 2 and 333, indicating that there may be more than three devices 140 each with a unique number on the Internetwork 100.

The Network 130, in turn, includes simple BACnet Devices 150, which are similar to the devices 140, but for the purposes of this example, are assumed to be low on resources and slow devices. They too have numbers associated with them, which define the BACnet Device Instance Numbers and uniquely identify the devices on the BACnet Internetwork 100. In this case, the Device Instance Numbers are chosen as 21, 22 and 2333, suggesting that there may be more than three devices 150.

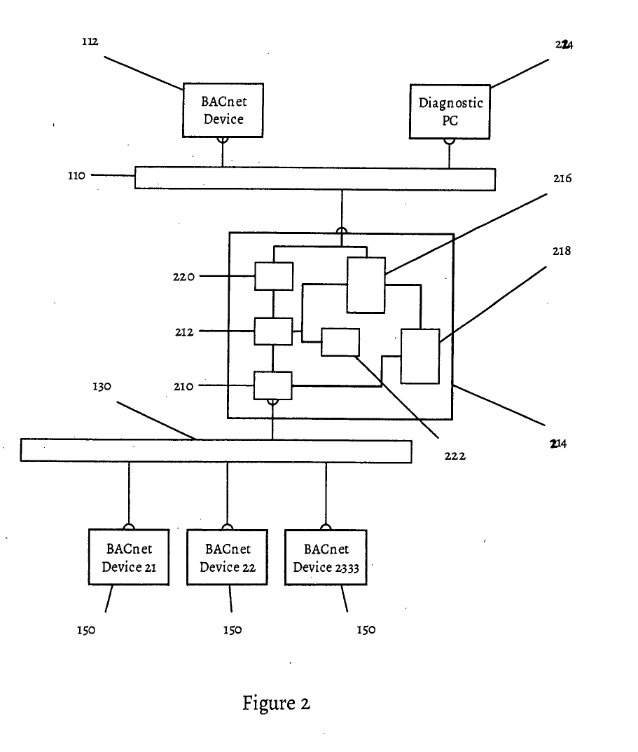

FIG. 2 shows one embodiment of a BACnet Internetwork of the invention. The BACnet Router is shown in greater detail since it is structurally and functionally different from the prior art BACnet Router. Nevertheless, many similarities exist between the BACnet Internetwork shown in the prior art example of FIG. 1 and that shown in the embodiment of FIG. 2. Therefore the same reference numerals have been retained to depict similar elements in FIG. 2.

The BACnet Router 214 of the invention, will for ease of reference also be referred to as an Advanced BACnet Router or ABR.

The ABR 214 shows some of the internal functional blocks that distinguish it over a conventional BACnet Router 114.

The ABR 214 includes a physical transceiver 210 that interfaces a CPU 212 inside the ABR 214 to the BACnet Network 130. In this embodiment the transceiver 210 comprises an EIA-485 transceiver but it could, in other applications, be one of the other BACnet transceiver types supported by the BACnet protocol.

The CPU 212 and program logic perform the BACnet routing, application layer logic and other housekeeping that allows for a logical connection between the two transceivers 210, 220. The CPU and transceivers define the components that form the basis of a standard BACnet Router. However the Advanced BACnet Router (ABR) of the invention includes additional electronics and program logic.

The Internetwork in this embodiment further includes a PC 224 running diagnostic software and diagnostic display programs. The ABR 214 includes additional functional blocks, such as a packet logging and diagnostic packet forwarding functional block 216 that is implemented as a software module, and performs logging of information, diagnostics, and packet forwarding, and provides additional program logic that allows the system to monitor the activities of the CPU 212 and instrumentation electronics 218, make calculations and reports, and relay this information to diagnostic software running on the diagnostic PC 224.

The ABR 214, further includes instrumentation electronics 218, also referred to herein as diagnostic electronics, to measure the physical Network parameters such as voltage, waveform, noise and other physical measurements. The electronics can, for example, perform the functions of a multimeter, oscilloscope, serial analyzer, spectrum analyzer, etc. In this embodiment it is internally connected to the BACnet Network 130. It will be appreciated that in different implementations some of the functionality described in this embodiment, may not be included.

In order to interface the CPU 212 to the first BACnet Network 110, a physical transceiver 220 interfaces the CPU 212 inside the BACnet Router 114 to the BACnet Network 110. In this embodiment the transceiver 220 is a 100baseT Ethernet transceiver.

An internal memory cache 222 is included in the Advanced BACnet Router 214 for storing relevant message and device information, and for temporary storage of BACnet protocol packets or messages in queues, as is discussed in greater detail below.

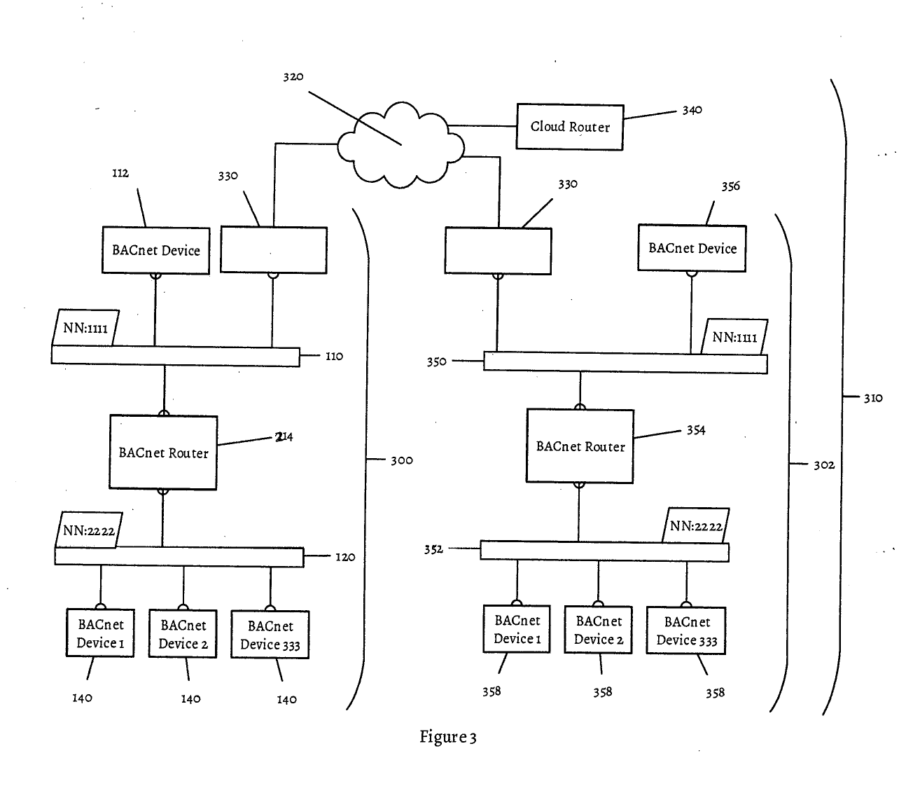

FIG. 3 shows two BACnet Internetworks 300, 302 connected to the Internet 320, and forming part of a larger Internetwork 310. For ease of reference, due to similarities between the BACnet Networks 110, 120 of FIG. 1 and the BACnet Networks of Internetwork 300 of FIG. 3, the same reference numerals have been used to depict similar elements in FIG. 3. Standard, commercially available, Internet Modem/Firewall/Routers 330 are provided that connect the physical Internetworks 300, 302 to the Internet 320. It will be appreciated that even though the Modem/Firewall/Routers 330 are shown as single diagram boxes, they may in practice comprise several separate physical devices, e.g., an Internet modem and an IP router, in one possible configuration.

In the case of Internetwork 300 the BACnet Network 120 is therefore connected via BACnet Router 114 to BACnet Network 110, which links to BACnet Device 112 and to a standard Internet modem 330. The modem 330 in turn links the BACnet Internetwork 300 to the Internet 320. BACnet Devices 140 are all connected to Network 120.

On Internetwork 302 the BACnet Network 352 is connected via BACnet Router 354 to BACnet Network 350, which links to BACnet Device 356 and a standard Internet modem 330, which in turn joins the BACnet Internetwork 302 to the Internet 320. BACnet devices 358 are all connected to Network 352.

The system, in this embodiment, further includes a computer 340, also referred to herein as a Cloud router, which may either be located elsewhere on the Internet or co-located with the BACnet equipment, but with a publicly accessible IP address that acts as a router of packets from one site to another.

In the present embodiment shown in FIG. 3, the system therefore includes a first BACnet Internetwork 300 and a second BACnet Internetwork 302. The second Internetwork 302 may be based, for example, at a different building, site, or campus location in a different geographical location to the first Internetwork 300. A third BACnet Internetwork 310 may be defined, which in this embodiment is configured as a superset that contains both the first and second BACnet Internetworks 300, 302 as discussed in greater detail below.

For completeness, the Internetwork 302 shown in FIG. 3 includes two BACnet Networks 350, 352 connected by a BACnet Router 354. The first BACnet Network 350 includes a single device 356 in this embodiment, while the second BACnet Network 352 includes multiple devices 358.

It will be noted that the BACnet Devices 358 on the second BACnet Internetwork 302, in this embodiment, have the same BACnet Device Instance Numbers as the devices 140 on the first BACnet Internetwork 300. The present invention makes this possible through an aliasing functionality, which is discussed in greater detail below. Similarly, it will be noted that the BACnet Network 352 on BACnet Internetwork 302 is provided with a Network Number 2222, which is the same as that of the BACnet Network 120 on the BACnet Internetwork 300. Similarly, BACnet Network 350 on BACnet Internetwork 302 is provided with a Network Number 1111, which is the same as that of the BACnet Network 110 on the BACnet Internetwork 300. Again, the present invention makes this possible through the aliasing functionality, which is discussed in greater detail below.

### Operation

As BACnet Networks get larger, sometimes including many tens of thousands of devices and hundreds of thousands of data points, network traffic congestion and throughput issues become significant. The present invention provides some relief to this problem. In addition, it identifies faults within the BACnet Networks and notifies operators to allow resolution.

Message Caching In FIG. 1 a BACnet device, e.g. the BACnet Operator Workstation 112 can discover other devices on the Network by broadcasting a Who-Is message. All devices 140 and 150 receiving the Who-Is message are required to respond with an I-Am message. On slow Networks such as BACnet/MSTP 130 the transfer of many dozens of I-Am messages consumes significant bandwidth. Referring also to FIG. 3, if there are multiple Who-Is requests, either from a single source, or even multiple sources, the responses result in multiple, redundant, I-Am messages from all the attached devices 140.

It will be appreciated that as the complexity of the Internetwork increases and the number of BACnet devices increases, such as the devices 112, 140, 356, 358 in the embodiment of FIG. 3, so the message congestion increases.

Since, by design, all these messages to and from these devices have to pass through at least one of the Advanced BACnet Routers 214, 354, there is an opportunity to monitor the first Who-Is and the corresponding I-Am messages and store the pertinent information into an internal cache, such as the cache 222 shown in FIG. 2, for future reference. When subsequent Who-Is messages arrive from any device on any Network, the system is able to examine this cache and respond immediately with an I-Am on behalf of the original device, without having to forward the Who-Is to the other connected Networks and then having to wait for the I-Am responses. This has the multiple benefit of speeding up the response, reducing the Network bandwidth consumption, especially on the slow Networks such as BACnet/MSTP, and reducing the CPU load on the BACnet Devices 112,150, in the FIG. 2 embodiment, or BACnet Devices 112, 140, 356, 358, in the FIG. 3 embodiment.

Referring again to FIG. 3, in addition to Who-Is/I-Am messages, a similar sequence can be performed with Who-Has/I-Have messages, as well as messages intended to read the various parameters and values of data objects within the devices 112, 140, 356, 358. For example, if a Read Property of the Device Name is performed once, and the data part of the response is stored in cache, then there is no need to forward subsequent Read Property messages to the device itself. The BACnet Router can instead respond immediately with the data stored in the cache.

It should be noted that some types of data in the devices 112, 140, 356, 358 will not change in the lifetime of the device, and can be cached indefinitely (e.g. Model Number). Other types of data change continuously. In each case, a judicious set of rules is applied to refresh the data in the cache 222 (FIG. 2) on a controlled basis, either by allowing a Read Property to be retransmitted and refreshing the data on the response, or else by reading the property on a cyclical basis. Some types of data may never be cached, and the rules for each data type and Device Instance Number is configured by the system installer for the device, the site, and the intended purpose of the device.

Circumstances such as adding a new device or removing a device from a Network are also considered and accommodated.

Consider the prior art Internetwork shown in FIG. 1. Network 110 was defined as a BACnet Network with a large bandwidth capacity. In contrast Network 120 in FIG. 1 was a low-bandwidth Network. Decoupling the two Networks via a cache of the present invention such as that discussed with respect to FIG. 2, will allow the high speed devices on the high speed Network to proceed at full speed, while protecting the slow Network 120 from all the excess traffic.

It should be noted that in the prior art, address and other caching is commonly done at the Operator Workstation level 112. In accordance with the invention, however, the caching is done within the Advanced BACnet Router of the invention, where the caching is more effective. Typically prior art devices cache the address part only, and poll for the data part. The ABR in this embodiment will cache not only the address but also the data part of the message.

### Queuing

The ABR has sophisticated queue management functions. Messages are queued in internal memory cache 222 while waiting their turn to be sent. If there are duplicate messages that contain redundant data (for example duplicate I-Am and Who-Is messages), then in some cases the duplicate messages may be deleted to avoid retransmission of redundant packets on the Network, thus increasing Network performance.

### Smart Routing

During operation, the ABR collects a substantial amount of Network topology information. With this information, the ABR can make informed decisions regarding the routing of some messages, for example, if the ABR knows that a device is on a given BACnet Network, it can avoid sending broadcast messages to all the other Networks. The topology information is derived by observing the addressing/routing information that is included in standard BACnet packets. Normally this information is only used once for the packet in question. The ABR of the present invention makes note of this addressing information for future use thereby optimizing the routing. The ABR also actively explores the Network using standard BACnet messages and builds up an internal map of BACnet devices and their locations.

### Blocking

For security and other purposes, such as maintenance, it may be desirable to block a device from other Networks. Based on suitable configuration data provided to the ABR, for example from an operator work station or BACnet controller 112 or from a Diagnostic PC 224 (FIG. 2), the ABR can examine the source address information of an incoming message, and if so configured, prevent the forwarding of this message, effectively disconnecting the unwanted or unauthorized device from the rest of the BACnet Internetwork.

### Pre-Discovery

Upon power up, the ABR does not need to wait passively for incoming messages in order to populate the information cache. By providing polling logic on the functional block 216, the ABR is able to actively poll for some of the information and build the cache in anticipation of future incoming requests. This has the benefit of allowing, for example, the startup process of an Operator Workstation 224 to re-initialize much faster.

### Provisioning

Some simple BACnet Devices do not contain some of the optional BACnet properties, for example, the Description Property of an object. The ABR can be provisioned via a configuration process with the missing information, so that when another device polls for that information from the device, the response is generated within the ABR on behalf of the simple device. In some cases, this provisioning can be done automatically within the ABR, using the functional block 216, but in other cases it will have to be done via configuration input from an operator, for example, from workstation 112.

### Functional Enhancements

The BACnet specification contains a particular service called Change Of Value (COV) which reduces Network bandwidth consumption by allowing one or more BACnet Devices to register with a data property of interest, and once registered, and only when suitable conditions are met, such as a change of value out of a configured delta range is detected, is a message generated on the Network. This has the great benefit of eliminating the need to continuously poll for the data. However, not all, and indeed most simple devices do not support this powerful option. In the prior art systems this functionality is typically implemented on the BACnet devices 140 150, but in order to do so, the device needs significant resources, (memory, CPU power, real time clock) that may not be available on the simpler devices. Since it is an optional function (or service), most manufacturers choose to skip this service completely. The ABR can act as a proxy for these simple devices, polling for the data from the simple device in a controlled fashion, and then providing this data as a COV service to other devices that desire to subscribe to changes in the data value. Other services can also be implemented using this proxy approach, for example, but not limited to, adding a security layer, based on the BACnet security standard.

### Diagnostics

A multitude of diagnostic services for traffic and protocol monitoring are also performed by the ABR. With reference to FIG. 2, functional block 216 makes, copies of packets, adds timing and Network parameter information in a wrapper, and forwards these to the Diagnostic PC 224 for examination and logging in reports, or using some sort of BACnet traffic analysis tool or Network Monitor tool.

Response times of each of the devices connected to the ABR are monitored by the ABR and if the results of these measurements indicate congestion problems at the Network or device level, this is reported or alarmed so that operator action can be taken to reconfigure or replace devices, as discussed below. Ongoing logging of a device's performance profile can be made for review at a later date.

Packet losses are also detected and reported and perhaps alarmed. This allows failed or faulty devices, or devices with poor electrical connections, to be diagnosed, identified and repaired or replaced.

Duplicate Device Instance Numbers and Network Numbers are detected and either aliased as discussed further below, or blocked, and reported, e.g., to the diagnostic PC 224 or the workstation 112 so an operator can make informed decisions regarding resolution of the problem.

Slow devices are identified for possible replacement or reconfiguration

Failed or bottleneck devices are identified for possible replacement or reconfiguration

The voltage levels of the connected Networks 110,130 are sampled by an onboard electronic subsystem 218 and the results provided to the diagnostic PC 224, which can show the samples in various formats such as an oscilloscope view, a spectrum analyzer view, an Eye-diagram view etc., allowing a qualified operator to observe the electrical condition of the Network. Problems such as signal attenuation, electrical noise, mis-wiring, ground loops and other electrical problems can be identified in this way.

In addition, the instrumentation electronics 218, also referred to herein as the electronic subsystem 218 can allow resistor networks to be temporarily or permanently added (internally, and automatically, in a diagnostic sequence) to the connected Networks to allow, through a series of tests, the diagnosis of the termination and biasing condition of the Networks.

### Aliasing

If the devices and Network Numbers in FIG. 3 are examined, it will be seen that there is a duplication of the Device Instance Numbers of devices 140 and 358 as well as the Network Numbers for the Networks 110 and 350. A BACnet Internetwork requires that all Networks and devices have uniquely assigned Network Numbers, Device Instance Numbers and Device Object Names. Therefore, these two Networks cannot be directly connected together and interoperate as one extended BACnet Internetwork. However, the ABR allows aliasing, or reassigning, these parameters. This means that during the relay of BACnet packets, the above parameters are examined within the communications packets, and if there is a collision, the ABR re-allocates a new parameter before forwarding the packet. This means that devices in BACnet Internetwork 300 can see the devices in BACnet Internetwork 302 (and vice versa), but with new, aliased Network Numbers, Device Instance Numbers and Device Object Names. Once again, this aliasing can be performed automatically or per an operator configuration process, for example via a workstation 112 or diagnostic PC 224.

Typically Internet routers 330 prevent the transfer of broadcasts, and the BACnet specification describes a solution to this problem using BACnet Broadcast Management Devices (BBMDs). However, BBMDs are extremely confusing for the average site technician to configure and are often misconfigured, or cannot achieve the desired connectivity due to some technical limitation. The ABR e.g. 214 of the present invention solves all these problems by sending the BACnet packet from one BACnet Network, e.g. 300 along with additional addressing information over the Internet 320 to the Cloud router 340, which by examining the BACnet packet and additional addressing information, can forward the BACnet packet with the additional information to another ABR e.g. 354, which interprets the received data and forwards the BACnet part of the message onto its local BACnet Internetwork 302. By this means, transparent connectivity between two similar sites, with conflicting Network numbers is achieved, providing effectively a single, larger BACnet Internetwork 310.

### Alternative Embodiments

It should be noted that more than one ABR can be installed on a BACnet Internetwork, and that there may be a number of ABRs between any two given BACnet Devices.

It should be noted that the system described in the embodiments shown in FIGS. 2 and 3 can be implemented in different configurations and with all or only some of the functionality described above. For instance, the diagnostic software installed on the Diagnostic PC 224 in FIG. 2 could instead be installed on the Operator Workstation 112 or in the ABR itself (along with a suitable operator interface, for example, to define an embedded web server, but not necessarily being limited to, an embedded web server.)

The Cloud router 340 of FIG. 3 need not be connected to the Internet as shown in the above embodiments. It could instead be co-located with either of the BACnet Internetworks 300 or 302, and could also be embedded within an actual ABR, and still produce the desired results.

The ABR is not limited to two or even three Network connections. These connections could also be multiple logical connections over a single physical Network, using a logical method such as UDP port numbers, to keep the Network Numbers separated logically. The number of connections is therefore limited by the available CPU and memory resources only, for instance the CPU 212 and cache 222.

The Network connection could be any alternative physical connection, e.g. LonWorks, Power Line (PLC) or wireless implementation, such as WiFi, Zigbee, Bluetooth or some other technology.

The Diagnostic software, instead of being installed on a PC 224, could be installed in a portable device, such as a smartphone.

Even though the above embodiments described the caching technology being contained within a BACnet Router, the same functionality could be implemented in devices other than BACnet Routers, such as Protocol Translator gateways. For ease of description these devices will all be referred to as Advanced BACnet Routers or ABRs.

The Cloud router functionality could be provided either using custom programming and special services, or could take advantage of standard internet relay and message broker services, for example, but not limited to, XMPP, MQTT, and cloud based queueing services e.g. Microsoft Azure.

The diagnostic and configuration services of the ABR could be presented on the Network as BACnet Objects and Properties, allowing other BACnet compatible devices to monitor and control the operation of the device and hence the BACnet Internetwork. Thus, while the embodiments described above with respect to FIGS. 2 and 3 presented the diagnostic information on a diagnostic PC 224, the same information could instead be presented as an internal “BACnet Object” in the ABR to allow access from, and compatibility with, other standard BACnet devices and workstations.

Even though a BACnet Internetwork may be implemented in a single building or campus in a single geographic location, a BACnet Internetwork can also be fully distributed globally, and is not geographically restricted in any way.

While the embodiments discussed with respect to FIGS. 2 and 3 included all of the functionality in the ABR, the functionality can instead be distributed. For instance, some of the functionality of the ABR, such as the packet logging and diagnostic packet forwarding functional block 216 can instead be installed in other (3^{rd} party) routers in order to enhance them.

One embodiment of the invention could involve ABRs with different functional capabilities. For instance, one ABR can be configured as a ‘master’ Router for a Network, controlling a number of ‘slave’ BACnet Routers. The ‘master’ ABR would take the role described above, optimizing and analyzing the packets, and finally sending the optimized set of BACnet packets to the Network slave devices over a high speed Network (Ethernet), and the Network slaves would only have to forward and return packets to the slower end-devices. This means the complex processing occurs only in the Network master ABR, and the Network slave Routers can be very simple devices, with minimal resource requirements and thus very inexpensive. An architecture of one Network master ABR and a multitude of Network slaves would be much more cost-effective than an alternative where the Routers all have the same full complement of capabilities.

What is claimed is:

1. An Advanced BACnet Router (ABR) for linking together multiple BACnet Networks in a BACnet Internetwork of BACnet devices communication with each other using the BACnet protocol, comprising
a processor that includes program logic to perform at least one of signal routing, application layer logic, and housekeeping to logically connect the BACnet Networks
transceivers for interfacing each BACnet Network with the processor, and at least one of
a packet logging functional block,
instrumentation electronics for measuring Network parameters, and
a memory cache for storing at least one of messages, BACnet device information, and BACnet-protocol packets.

2. A BACnet Router of claim 1, wherein the packet logging functional block performs at least one of logging of information, diagnostics, and packet forwarding.

3. A BACnet Router of claim 2, wherein the tasks of the packet logging functional block include at least one of monitoring of the processor, monitoring of the instrumentation electronics, performing calculations, and creating reports.

4. A BACnet Router of claim 1, wherein the memory cache is configured to store one or more of the first I-Am information generated by BACnet devices in response to Who-Is messages, the first I-Have information generated in response to Who-Has messages, and parameters and values of data objects within the BACnet devices.

5. A BACnet Router of claim 4, where the cache includes BACnet device property information that is provided as part of a configuration process.

6. A BACnet Router of claim 1, wherein the cache is configured to communicate with at least one of the packet logging functional block and an external work station.

7. A BACnet Router of claim 6, wherein the packet logging functional block includes polling logic to actively poll for defined information and build the information in the cache.

8. A BACnet Router of claim 2, wherein the packet logging functional block is configured to perform diagnostic services for traffic and protocol monitoring by making copies of communications packets, and optionally adding timing and Network parameter information, and forwarding these to a diagnostic processor.

9. A BACnet Router of claim 1, wherein the BACnet Router is configured to serve as a proxy for simple BACnet devices by including logic to perform a change of value service that generates a message when a change of value outside a defined delta range is detected for a BACnet device.

10. A BACnet Router of claim 9, wherein the configuration of the BACnet Router to perform proxy functionality includes adding a security layer based on the BACnet security standard.

11. A BACnet Router of claim 1, wherein the instrumentation electronics is configured to add resistor sequences to the connected BACnet Networks to diagnose termination and biasing conditions.

12. A BACnet Router of claim 1, further comprising a diagnostic processor running diagnostic software.

13. A BACnet Router of claim 12, wherein the diagnostic processor includes at least one of a diagnostic display program and an operator interface.

14. A BACnet Router of claim 1, further comprising a cloud router.

15. A method of improving communications between BACnet devices in a BACnet Internetwork that includes multiple BACnet Networks, the method comprising
providing a cache to capture the addresses and data parts of messages sent between BACnet devices.

16. A method of claim 15, wherein the messages are queued and duplicate messages are deleted.

17. A method of claim 15, further comprising collecting Network topology information.

18. A method of claim 17, wherein the collecting comprises caching address/routing information of BACnet messages.

19. A method of claim 15, the collecting includes actively exploring the BACnet Networks using standard BACnet messages to build an internal map of the BACnet devices and their locations.

20. A method of claim 15, wherein the cache is implemented in a BACnet Router, and the cache is configured to identify unauthorized or disconnected devices to allow the BACnet Router to prevent forwarding of messages to the unauthorized or disconnected device.

21. A method of claim 20, wherein duplicate Device Instance Numbers and Device Object Names of BACnet devices, and duplicate Network Numbers of BACnet Networks on a BACnet Internetwork are aliased or reassigned in the communications packet before forwarding.

22. A method of claim 21, wherein the aliasing is performed automatically by a diagnostic processor communicating with the BACnet Router, or through an operator configuration using a workstation communicating with the BACnet Router.

23. A method of claim 15, wherein transfer of broadcasts between Internet routers is achieved by sending a BACnet packet associated with the broadcast along with additional addressing information that allows a Cloud router to transfer the BACnet packet with the additional addressing information to the appropriate BACnet Router where the BACnet packet part of the message is forwarded on to the BACnet Router's BACnet Internetwork.
